(19) United States
(12) Patent Application Publication
(10) Pub. No.: US 2013/0041508 A1
(43) Pub. Date: Feb. 14, 2013

(54) SYSTEMS AND METHODS FOR OPERATING ROBOTS USING VISUAL SERVOING

(71) Applicants: Ai-Ping HU, Atlanta, GA (US); Gary McMurray, Atlanta, GA (US); James Michael Matthews, Atlanta, GA (US); Matt Marshall, Atlanta, GA (US)

(72) Inventors: Ai-Ping HU, Atlanta, GA (US); Gary McMurray, Atlanta, GA (US); James Michael Matthews, Atlanta, GA (US); Matt Marshall, Atlanta, GA (US)

(73) Assignee: Georgia Tech Research Corporation, Atlanta, GA (US)

(21) Appl. No.: 13/584,594

(22) Filed: Aug. 13, 2012

Related U.S. Application Data
(60) Provisional application No. 61/522,889, filed on Aug. 12, 2011.

(51) Int. Cl. B25J 13/08

(52) U.S. Cl. 700/259; 901/9; 901/47

(57) ABSTRACT

A system and method for providing intuitive, visual based remote control is disclosed. The system can comprise one or more cameras disposed on a remote vehicle. A visual servoing algorithm can be used to interpret the images from the one or more cameras to enable the user to provide visual based inputs. The visual servoing algorithm can then translate that commanded motion into the desired motion at the vehicle level. The system can provide correct output regardless of the relative position between the user and the vehicle and does not require any previous knowledge of the target location or vehicle kinematics.

### CROSS REFERENCE TO RELATED APPLICATIONS

This application claims benefit under 35 USC §119(e) of U.S. Provisional Patent Application Ser. No. 61/522,889, entitled “Using Visual Servoing with a Joystick for Teleoperation of Robots” and filed Aug. 12, 2011, which is herein incorporated by reference as if fully set forth below in its entirety.

### BACKGROUND OF THE INVENTION

1. Field of the Invention

Embodiments of the present invention relate generally to robotics, and more specifically to intuitively controlling robotics using visual servoing.

2. Background of Related Art

Robots are widely used in a variety of applications and industries. Robots are often used, for example, to perform repetitive manufacturing procedures. Robots have the ability, for example and not limitation, to precisely, quickly, and repeatedly place, weld, solder, and tighten components. This can enable robots to improve product quality while reducing build time and cost. In addition, unlike human workers, robots do not get distracted, bored, or disgruntled. As a result, robots are well-adapted to perform repetitive procedures that their human counterparts may find less than rewarding, both mentally and financially.

Robots can also be used to perform jobs that are impossible or dangerous for humans to perform. As recently seen in Chile, small robots can be used, for example, to locate miners in a collapsed mine by moving thorough spaces too small and unstable for human passage. Robots can also be designed to be heat and/or radiation resistant to enable their use, for example, for inspecting nuclear power plants or in other hostile environments. This can improve safety and reduce downtime by locating small problems for repair prior to a larger, possible catastrophic failure.

Robots can also be used in situations where there is an imminent threat to human life. Robots are often used during SWAT operations, for example, to assess hostage or other high risk situations. The robot can be used, for example, to surveil the interior of building and to locate threats prior to human entry. This can prevent ambushes and identify booby-traps, among other things, improving safety.

Another application for robots is in the dismantling or destruction of bombs and other explosive devices. Robots have been used widely in Iraq and Afghanistan, for example, to locate and diffuse improvised explosive devices (IEDs), among other things, significantly reducing the loss of human life. Explosive ordnance disposal (EOD) robots often comprise, for example, an articulated arm mounted on top of a mobile platform. The EOD robot is generally controlled by an operator using a remote control, using of a variety of sensors, including on-board cameras for visual feedback to locate the target object. This may be, for example, a road side bomb, an abandoned suitcase, or a suspicious package located inside a vehicle.

EOD robots often have two modes of operation. The first mode comprises relatively large motions to move the robot within range of the target. The second mode provides fine motor control and slower movement to enable the target to be carefully manipulated by the operator. This can help prevent, for example, damage to the object, the robot, and the vehicle and, in the case of explosive devices, unintentional detonations. Once the target has been identified, therefore, the operator can direct the robot into the general vicinity of the target making relatively coarse movements to close the distance quickly. When the robot is sufficiently close to the target (e.g., on the order of tens of inches), the commanded motions can then become more refined and slower.

In practice, short meandering motions are often taken to obtain multiple views of the target and its surroundings from different perspectives. This can be useful to gain a more 3D feel from the 2D cameras to help assess the position, or “pose,” required between the EOD robot end-effector and the target object. Due to the difficulty of visualizing and re-constructing a 3D scenario from 2D camera images, however, this initial assessment can be time-consuming and laborious, which can be detrimental in times sensitive situations (e.g., when assessing time bombs). In addition, the resultant visual information must then be properly coordinated by the operator with the actuation of the individual robot joint axes via remote control to achieve the desired pose. In other words, while the operator may simply want to move the robot arm to the left, conventional control systems may require that he determine which actual joint on the robot he wishes to move to create that movement.

Coordinating individual joint movements can become particularly confusing and unintuitive when the operator and the robot are in different orientations or when the operator must rely solely on video feedback (e.g., the robot is out of sight of the operator). In other words, when the robot is facing a different direction than the operator, or the operator cannot see the robot, the operator often has to perform a mental coordination between his commands and the robot's movement, often as it is depicted on a video screen. This can be, for example, coordinate transformations from the video screen to actual motion at the robot's joints.

What is needed, therefore, are efficient and intuitive systems and methods for controlling robots, and other remotely controlled mechanisms. The system and method should enable an operator to move the robot in the desired direction in an intuitive way using a video screen, for example, without having to perform coordinate transformations from the video scene to individual joint movements on the robot. It is to such a system and method that embodiments of the present invention are primarily directed.

### BRIEF SUMMARY OF THE INVENTION

Embodiments of the present invention relates generally to robotics, and more specifically to intuitively controlling robotics using visual servoing. In some embodiments, visual servoing can be used to enable a user to remotely operate a robot, or other remote vehicle or machine, using visual feedback from onboard cameras and sensors. The system can translate commanded movements into the intended robot movement regardless of the robot's orientation.

In some embodiments, the system can comprise one or more 2D or 3D cameras to aid in positioning a robot or other machine in all six dimensions (3 translational and 3 rotational positions). The cameras can be any type of camera that can return information to the system to enable the tracking of points to determine the relative position of the robot. The system can comprise stereo 2D cameras, monocular 2D cameras, or any sensors capable of yielding a transformation solution in 6D, including laser scanners, radar, or infrared cameras.

In some embodiments, the system can track objects in the image that repeat from frame to frame to determine the relative motion of the robot and/or the camera with respect to the scene. The system can use this information to determine the relationship between commanded motion and actual motion in the image frame to provide the user with intuitive control of the robot. In some embodiments, the system can enable the use of a joystick, or other controller, to provide consistent control in the image frame regardless of camera or robot orientation and without known robot kinematics.

Embodiments of the present invention can comprise a method for providing visual based, intuitive control. In some embodiments the method can comprise moving one or more elements on a device, measuring the movement of the one or more elements physically with one or more movement sensors mounted on the one or more elements, measuring the movement of the one or more elements visually with one or more visual based sensors, comparing the measurement from the one or more movement sensors to the measurement from the one or more visual based sensors to create a control map, and inverting the control map to provide visual based control of the device.

In other embodiments, the method can further comprise receiving a control input from a controller to move the device in a first direction with respect to the visual based sensor, and transforming the control input to move the one or more elements of the device to move the device in the first direction. In some embodiments, the controller comprises one or more joysticks.

In some embodiments, the one or more visual based sensors comprise one or more 2-D video cameras. In other embodiments, the one or more visual based sensors comprise stereoscopic 2-D video cameras. In an exemplary embodiment, the device can be a robotic arm comprising one or more joints that can translate, rotate, or both. In some embodiments, visually measuring the movement of the one or more elements can comprise identifying one or more key objects in a first image captured by the visual based sensor, moving one or more of the elements of the device, reidentifying the one or more key objects in a second image captured by the visual based sensor, and comparing the relative location of the one or more key objects in the first image and the second image.

Embodiments of the present invention can also comprise a system for providing visual based, intuitive control. In some embodiments, the system can comprise a device comprising one or more moveable elements each element capable of translation, rotation, or both, and each element comprising one or more movement sensors for physically measuring the movement of the element. The device can also comprise one or more image sensors for visually measuring the movement of the one or more elements. The device can further comprise a computer processor for receiving physical movement data from the one or more movement sensors, receiving visual movement data from the one or more image sensors, comparing the physical movement data to the visual movement data to create a control map, and inverting the control map to provide visual based control of the device.

In some embodiments, the computer processor can additionally receive a control input from a controller to move the device in a first direction with respect to the visual based sensor and transform the control input to move the one or more elements of the device to move the device in the first direction. In some embodiments, the device can comprise a robotic arm with one or more joints. In other embodiments, the robotic arm can also comprise an end-effector.

In some embodiments, the one or more image sensors can comprise one or more 3-D time-of-flight cameras. In other embodiments, the one or more image sensors can comprise one or more infrared cameras.

These and other objects, features and advantages of the present invention will become more apparent upon reading the following specification in conjunction with the accompanying drawing figures.

### BRIEF DESCRIPTION OF THE DRAWINGS

FIG. 1a depicts an experimental robotic arm with a gripper controlled in the image frame, in accordance with some embodiments of the present invention.

FIG. 1b depicts a flowchart of one possible control system, in accordance with some embodiments of the present invention.

FIG. 2 depicts the relative pose solution in sequential 3D image frames by tracking feature points, in accordance with some embodiments of the present invention.

FIG. 3 depicts a flowchart for the classification of objects by the system, in accordance with some embodiments of the present invention.

FIG. 4 is a graph depicting the time to complete a task using four different control methods, in accordance with some embodiments of the present invention.

FIG. 5 is a graph depicting the number of times the user changed directions to complete the task using the four different control methods, in accordance with some embodiments of the present invention.

FIG. 6 is a graph depicting the gripper position of the arm in Cartesian space with respect to time, in accordance with some embodiments of the present invention.

FIG. 7 is a 3-D graph depicting the gripper position of the arm in Cartesian space, in accordance with some embodiments of the present invention.

FIG. 8 is a graph depicting the distance between the gripper and the target object with respect to time, in accordance with some embodiments of the present invention.

### DETAILED DESCRIPTION OF THE INVENTION

Embodiments of the present invention relate generally to robotics, and more specifically to intuitively controlling robotics using visual servoing. In some embodiments, visual servoing can be used to enable a user to remotely operate a robot, or other remote vehicle or machine, using visual feedback from onboard cameras and sensors. The system can translate commanded movements into the intended robot movement regardless of the robot's orientation.

Embodiments of the present invention can comprise one or more algorithms that enable the images provided by one or more cameras, or other sensors, to be analyzed for a full 6D relative pose solution. This solution can then be used as feedback control for a visual servoing system. The visual servoing system can then provide assistance to the operator in the intuitive control of the robot in space.

To simplify and clarify explanation, embodiments of the present invention are described below as a system and method for controlling explosive ordinance disposal (“EOD”) robots. One skilled in the art will recognize, however, that the invention is not so limited. The system can be deployed any time precise and intuitive control is needed in a geometrically undefined space. As a result, the system can be used in conjunction with, for example and not limitation, drone aircraft, manufacturing equipment, automated vending machines, and robotic inspection cameras.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention, for example. Any dimensions listed in the various drawings are for illustrative purposes only and are not intended to be limiting. Other dimensions and proportions are contemplated and intended to be included within the scope of the invention.

As discussed above, a problem with conventional robotics controls has been that the controls tend to be joint based, as opposed to controlling the robot as a whole. As a result, affecting a particular motion on the robot arm often requires the operator to perform complicated transformations between the desired movement of the robot and the joint commands required for same. In many instances, this task is complicated by the fact that the operator does not have line of sight to the robot and is working solely from one or more video screens.

What is needed, therefore, is a system for properly and efficiently placing and/or aiming the EOD robot arm and/or gripper with respect to the target. Embodiments of the present invention, therefore, can utilize visual servoing, among other things, to enable such efficiency. Visual servoing is a methodology that utilizes visual feedback to determine how to actuate a robot in order to achieve a desired position and orientation, or “pose,” with respect to a given target objects. Advantageously, the method does not require precise knowledge of the robot geometry or camera calibration to achieve these goals.

Robotic systems are widely used in the military as commanders seek to reduce the risk of injury and death to soldiers. Remote controlled drone airplanes, for example, are use for surveillance and bombing missions. In addition, robotics can be used, for example and not limitation, for vehicle inspection at perimeter gates as well as forward-looking scouts in military missions. These robotics systems enable surveillance and inspection in high-risk situations without placing soldiers in harm's way.

As the use of these robotic systems expands, however, the number of operators required to operate them also expands. To reduce costs and improve efficiency, therefore, there is a desire to have a single operator control multiple robots, if possible. The use of robotics also facilitates another strategic goal, moving the operator away from line-of-sight operation of the robot. This can include on-site remote operation, i.e., placing the operator outside the blast range of an IED, in a bunker, or behind a shield. An important application of this technology is for use with Explosive ordinance disposal (EOD) robots. This can also include “teleoperation,” or remote operation from any place in the world. This enables, for example, an operator sitting safely in a control room in the United States to control a robot or drone operating in theater (e.g., in Afghanistan).

EOD robots, drones, and other remotely operated systems, however, are complex. The EOD robot, for example, generally consists of several key systems including, but not limited to, a mobile robot base, a robotic arm, a hand (or “end effector”), and one or more cameras. Typically, the robots are under direct control of one or more operators located at some (safe) distance from the task. The robots can be used, for example, to examine, remove, and/or dispose of suspicious objects that could be potential explosive devices.

Cameras can be placed on the EOD robot to provide the user with one or more 2D images of the environment. A problem with attempting to control a robot in 3D space, however, is presented by the difficulty of converting 2D camera images into usable 3D data for the operator. The data can be difficult to understand because, among other things, the user lacks a clear understanding of the relationship between the camera image, the real world, and the motions of the robot.

A simple example of this type of complexity is backing a car with a trailer. When backing a trailer, for example, steering inputs are reversed. In other words, turning the car to the left makes the trailer back to the right, and vice-versa. In a stressful or emergency situation, this analysis becomes difficult or impossible.

For the EOD operator, however, the situation is even more complex. The operator is controlling a multiple degree-of-freedom system that has a complex, often nonlinear, relationship between what the operator sees and commands and what happens. Conventional controls, for example, are often joint based requiring the operator to translate the desired motion into individual joint movements on the robot to produce the desired effect. Thus, the motion of the robot is generally not a simple linear translation, but can also include rotational motion about an unknown axis. As a result, most EOD tasks are currently performed with line-of-sight control to enable the user to observe the robot and establish a relationship between the camera view and the robot's motion. In addition, by definition, the operator is working in a stressful and dangerous environment.

Unfortunately, even line-of-site this does not eliminate the complexity of moving individual joints to achieve the desired pose. This also does not address the fact that motions of the robot may be reversed from, or otherwise different than, what the user expects due to the relative positions of the robot and the operator, among other things. If, for example, the base of the robot is pointing towards the operator, then a command to move the robot forward would actually move the robot toward the operator. Similarly, in this case, moving the robot arm to the left would actually move the robot to the right relative to the operator's point of view. Moving the robot as desired becomes exponentially more difficult if the robot is, for example and not limitation, inverted, looking backwards, but moving forward, or if the camera itself is somehow rotated or skewed.

Embodiments of the present invention, therefore, can comprise a system and method for providing an intuitive interface for controlling remote robots, vehicles, and other machines. In some embodiments, the system can operate such that the operator is not required to coordinate the transformations from the image provided by the one or more cameras to, for example, the correct motion for the robot or into individual joint commands. Providing a control system in the image frame is more intuitive to the user, which can, among other things, reduce operator training time, stress, and workload, improve accuracy, and reduce program costs. To this end, visual servoing algorithms can be used to learn the relationship between the camera image and the motions of the robot. This can enable the user to command the robot's movements relative to the camera image and the visual servoing algorithm can ensure that the robot, or individual components of the robot, moves in the desired direction.

Embodiments of the present invention can provide control regardless of camera location. In other words, the system can provide correct translation of motion regardless of whether the location of the camera is known or if the camera moves between uses, for example, due to rough handing. In addition, due to the closed loop, or feedback, nature of the algorithms used herein, an exact kinematic model of the robot is unneeded. The system can provide a simple and intuitive means for controlling robots, or other machines, with respect to one or more video images regardless of orientation using simple, known controllers.

### Visual Servoing

EOD robots are often subject to rough handling in the field and rough terrain in use. As a result, the factory, or “as-built,” kinematic model is often no longer accurate in the field. A very small deflection in the base, for example, can easily translate to errors approaching an inch or more at the tip of the robot's arm.

For larger motions, such as approaching the target area from distance, this is generally not an issue. In these situations, the operator would likely just make corrections to the path of the robot unaware that part of the problem may be caused by errors in the kinematic model. It is when finer control is required that these kinematic errors can become more apparent. When dealing with EOD applications, in particular, where inadvertent contact with a target object can result in detonation, for example, these errors can become a potentially deadly problem.

Visual servoing, on the other hand, provides a model-independent, vision-guided robotic control method. As a result, visual servoing can provide an advantageous alternative to pre-calculated kinematics. As described below, the uses image feedback to get close to a target object and properly control the robot's arm once within range. Visual servoing can solve the problem of providing the correct end-effector pose, regardless of robot or camera orientation and regardless of what joints, or other components, must be moved to affect that pose (assuming, of course, it is possible for the robot to attain that pose).

For a multi-joint arm, such as the arm shown, a particular command on a joint level will generally result in a somewhat non-intuitive movement of the end-effector. In other words, the motion transformation is governed by the robot's nonlinear forward kinematics and its position relative to the operator, among other things. Similarly, the image relayed by an eye-in-hand camera will seem to move in a non-intuitive fashion, depending on the relative position of the camera, among other things.

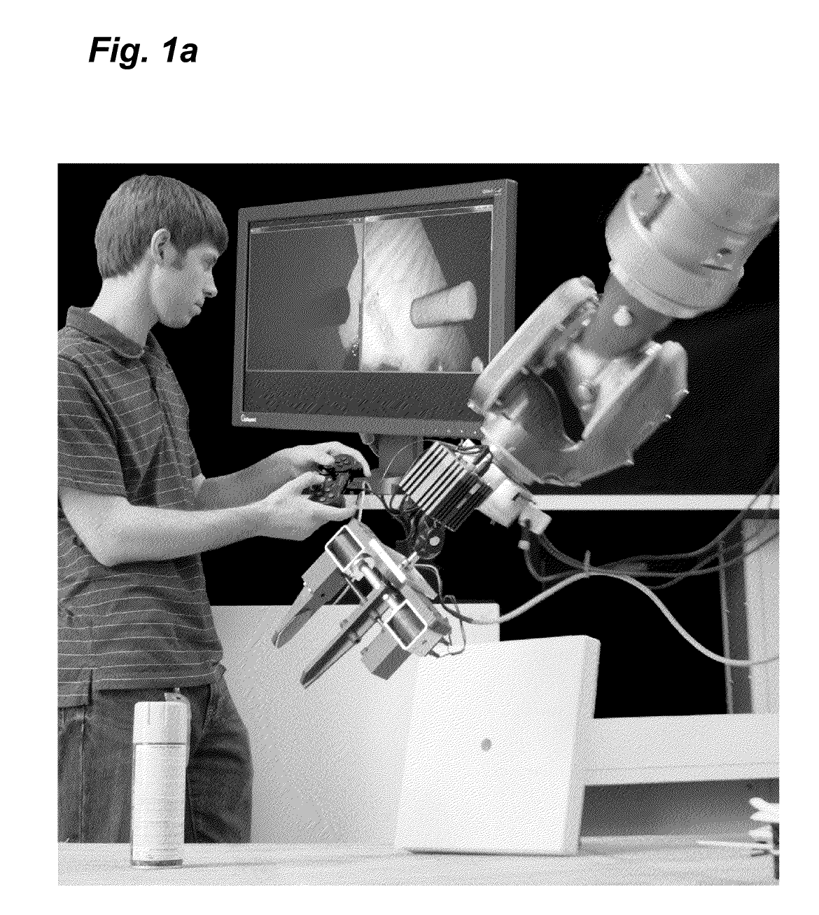

As shown in FIG. 1a, however, it is most intuitive for the user to control the motion in image frame, rather than in joint space. In other words, if, from the point of view of a user looking at a screen, the robot moves in a direction that is consistent with what the user sees, the user can easily and intuitively control the robot. If it is desired to position the end-effector slightly to the left of an object in the center of the image to try to peer around it, for example, then a user interface that implements that motion by allowing the user to simply push a LEFT button (or push left on a joystick, for example), as opposed to some coordination of movements using joint-based control, is advantageous.

Embodiments of the present invention, therefore, can comprise a system can method for remotely controlling objects in an intuitive way using visual servoing. Visual servoing can be used to control the relative movement of the robot within the image of a camera, or other device. The system can use this information to build a map relating robot movements and image movements, and then invert that map to enable robot control in the joint space, as specifically commanded by an operator.

A. Control Algorithm

Embodiments of the present invention can comprise a control algorithm for converting image information into robot control movements. As mentioned above, the system can use this information to build a map relating robot movements and image movements, and then invert that map to enable robot control in the joint space, as specifically commanded by an operator. The type of VS used is immaterial, as many different algorithms could be used. The system can use, for example and not limitation, Image Based (IBVS), Position Based (PBVS), or a hybrid of the two.

In an exemplary embodiment, the visual servoing system model can be assumed to be linear and thus, can be expressed as

δy≈Jδθ

where the output y is some measurable value and θ describes the system. The model used for the control algorithm can be

h_{y}=Ĵh_{θ}

where, at the k^{th} iteration, h_{yk}=yₖ−yₖ₋₁ and h_{θk}=θₖ−θₖ₋₁ and the term Ĵ denotes an estimate of J.

After each iteration and subsequent observation of the system state θ and output y, the Jacobian model can be updated according to the following:

$${\hat{J}}_{k} = {\hat{J}}_{k - 1} + \frac{( {h}_{yk} - {\hat{J}}_{k - 1} {h}_{{θ}_{k}} ) {h}_{{θ}_{k}}^{T} {P}_{k - 1}}{λ + {h}_{{θ}_{k}}^{T} {P}_{k - 1} {h}_{{θ}_{k}}} \\ {P}_{k} = \frac{1}{λ} ( {P}_{k - 1} - \frac{{P}_{k - 1} {h}_{{θ}_{k}} {h}_{{θ}_{k}}^{T} {P}_{k - 1}}{λ + {h}_{{θ}_{k}}^{T} {P}_{k - 1} {h}_{{θ}_{k}}} ) \qquad ( 2 )$$

where P can be initialized as the identity and the term X can be termed the “forgetting factor.” Of course, this is somewhat of a misnomer because the Jacobian update reacts to new data more slowly as X increases. As a result, the system actually forgets old information more quickly with a smaller λ.

Given these observations, the control action can be given by the Gauss-Newton method as

θ₍ₖ₊₂₎_{_{c}}=θ₍ₖ₊₁₎_{^{−}}+Ĵₖ⁺h_{yd}_{₍ₖ₊₁₎}₋ (3)

where Ĵ⁺ is the pseudo-inverse of Ĵ, h_{yd} is the desired output change, the minus sign on (k+1)-indicates values at a moment just prior to k+1, and the subscript c indicates that this will not necessarily be the joint position at k+2, but rather the commanded value. In other words, it is possible for there to be a difference because, for example and not limitation, the robot may be operating in velocity mode and the control period is dependent on the image processing time, among other things, which is variable. Of course, other techniques could be used to derive the control algorithm and are contemplated herein.

B. Difference Between Traditional VS and Gamepad-Driven

In a traditional position-based visual servoing (PBVS) system, the system output y is given in Cartesian coordinates and θ is given in robot joint angles. Conventional visual servoing, therefore, would have the desired output change in (3) as h_{yd(k+1)}=−fₖ, where f is the pose based error from (1), thus commanding the system toward zero error in the image plane. For the implementation presented here, however, the user can command the robot relative to the camera image by specifying motion in six degrees-of-freedom (three translational and three rotational) using a controller.

In other words, there is an algorithm that can covert a joystick command, e.g., for camera movement to the right, that will correspond to a translation command for the robot's arm to move in the positive x direction of the camera's frame. Similar transformations exist for commands along/about the other five camera degrees of freedom (DOF). The 6×1 vector describing this desired motion for each joint in the arm is denoted g. As a result, the visual servoing algorithm resolves the user-commanded motion (move left) into the proper joint movements, which may involve the rotation and/or translation of multiple joints to achieve. It follows, therefore, that h_{ydk}=gₖ, where gₖ is the current operator input (e.g., left) to the controller.

C. Perception

To control in all six camera DOF as described above, the vision system can solve for the Cartesian offset of the camera (i.e., its relative pose) from one image to another, hpk. Conveniently, a 3-D time-of-flight (“TOF”) camera outputs a 3-D point location for each pixel, which can enable a relatively simple transformation solution using standard computer vision methods. Also, similar methods with stereo or monocular 2D cameras, or other sensors capable of yielding a transformation solution in 6D, including laser scanners, radar, or infrared cameras.

This final 3-D transformation can comprise rotations (e.g., roll, pitch, yaw) and translations (e.g., x, y, z) of the camera with respect to the previous camera pose and is the feedback input into the model update portion of the VS algorithm as h_{yk}=hₚₖ. In other words, the camera pose has been updated to be equal to the commanded posed. Of course, as discussed above, some delay may be required for this to be true. At the start of each cycle of the VS algorithm, therefore, the camera can be triggered and this method can run to calculate the next 3-D transformation.

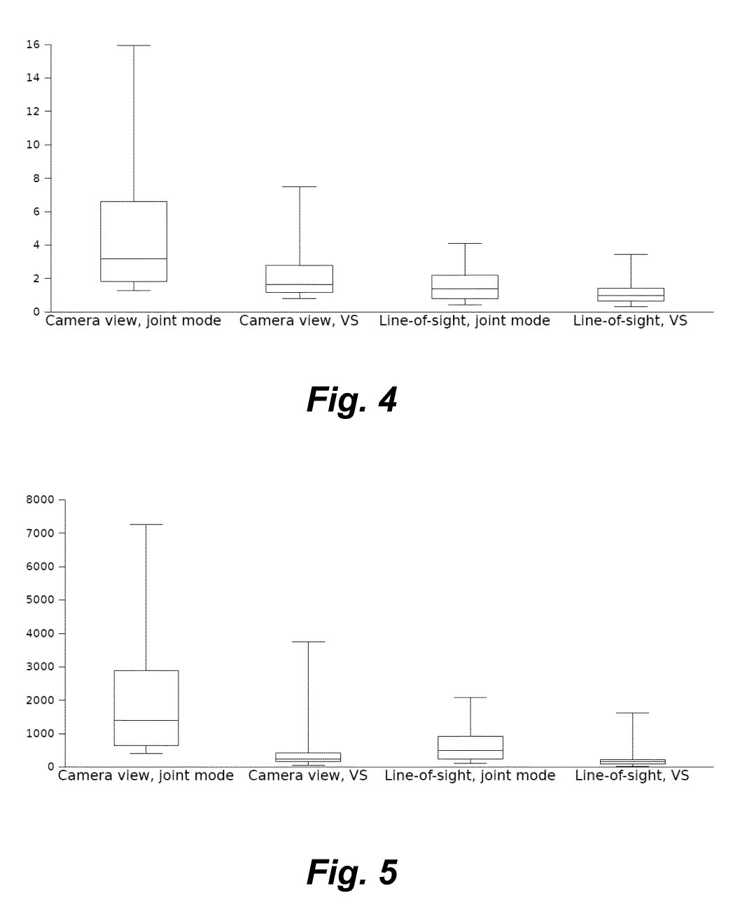

An example of found features and matches which contribute to the final 3D pose solution is depicted in FIG. 5. As shown, some of the depth information is difficult to grasp from a single 2D image, such as the bar in the upper left, and the height of the plate and screwdriver with respect to the table top. This is due in part to the fact that the motion shown is largely a rotation of the camera and not a translation, or a combination thereof. Note the tongs of the gripper in the lower right. As shown, many features are not matched due to, among other things, lower confidence of the 3D camera at edge regions during motion.

### EXPERIMENTAL RESULTS

A. Setup

To test the efficacy of embodiments of the present invention, a six degree-of-freedom articulated robot arm (shown in FIG. 1a) is used as the testbed. A KUKA robot comprising a 5 kg payload and six rotational joints is used. A KUKA Robot Sensor Interface (RSI) is used to convey desired joint angle offsets at an update rate of 12 ms. In addition, as shown in FIG. 1a, a custom electromechanical gripper on the robot is utilized. The gripper is used to demonstrate the relative dexterity of user control when issuing commands in the image frame compared to the joint space.

A 3-D time-of-flight camera is affixed to the end of the robot arm (i.e., eye-in-hand). The 3-D TOF camera used is the Swiss Ranger SR4000. One 3D camera is used and is placed on the end-effector. The camera uses active infrared lighting and multiple frame integrations to provide 3D coordinates for up to 25,344 pixels. The 3-D camera uses active-pulsed infrared lighting and multiple frames of the returned light, taken at different times, to solve for the depth at each pixel. The camera's optics are pre-calibrated by the manufacturer to accurately convert the depth data into a 3-D position image. The camera resolution is 176×144 pixels. For image analysis this provides roughly 300 feature points, yielding 50-200 matches per iteration, and takes 50-70 ms processing time. Analysis of image data takes place on a Windows 7 PC with an Intel Core 17-870 processor and 8 GB of RAM. This PC communicates with the robot joint-level controller using a DeviceNet connection, which updates every 12 ms.

The gamepad used is a Sony Playstation 3 DualShock controller, with floating point axis feedback to enable smooth user control. Motion-in-Joy drivers are used to connect it as a Windows joystick. National Instruments LabVIEW reads the current gamepad state, the value of which is then sent to the VS controller over TCP. A diagram of an exemplary configuration of the system is shown in FIG. 1b.

Joystick based control of the end-effector is fairly complex. This is due in part to the ability of the user to control the robot (and thus, the camera) in all six special degrees-of-freedom. As a result, the vision system must solve for the full relative pose from one image to another. This can be achieved by using a 3D camera. The 3D camera yields immediate 3D information without requiring structure from motion techniques. As a result, a relatively simple transformation solution can be performed using standard computer vision methods.

Before moving the robot, an initial estimate of the Jacobian is made by jogging the joints individually and recording the resulting measurement as a column of Ĵ. This is not a necessary step, but can be done to minimize the learning time, among other things. Also the gamepad position and joint angles are read and stored as g− and θ− respectively. This constitutes the system description at the start, i.e., at k=0. The initial movement, θ_{1c}, is computed using these three values and equation (3).

To begin a general iteration, the controller can first issue a command for the robot to move. As stated before the robot is operating in velocity mode so this command is a motion in the direction of θ_{c}. The perception subsystem, described above, can then be immediately triggered. The joint angles θₖ are read and the controller awaits the measurement h_{yk}=hₚₖ, i.e., the measured relative pose of the camera from k−1 to k. Once this data is received, the Jacobian estimate can be updated according to (2). Next, the joint angles and gamepad position can be re-read, as θ₍ₖ₊₁₎₋ and h_{yd(k+1)-}=g₍ₖ₊₁₎₋ respectively (again, the minus sign indicates values at a moment just prior to the robot reaching position (k+1). The final task for each iteration, therefore, is to compute the next desired joint position, θ₍ₖ₊₂₎, using (3).

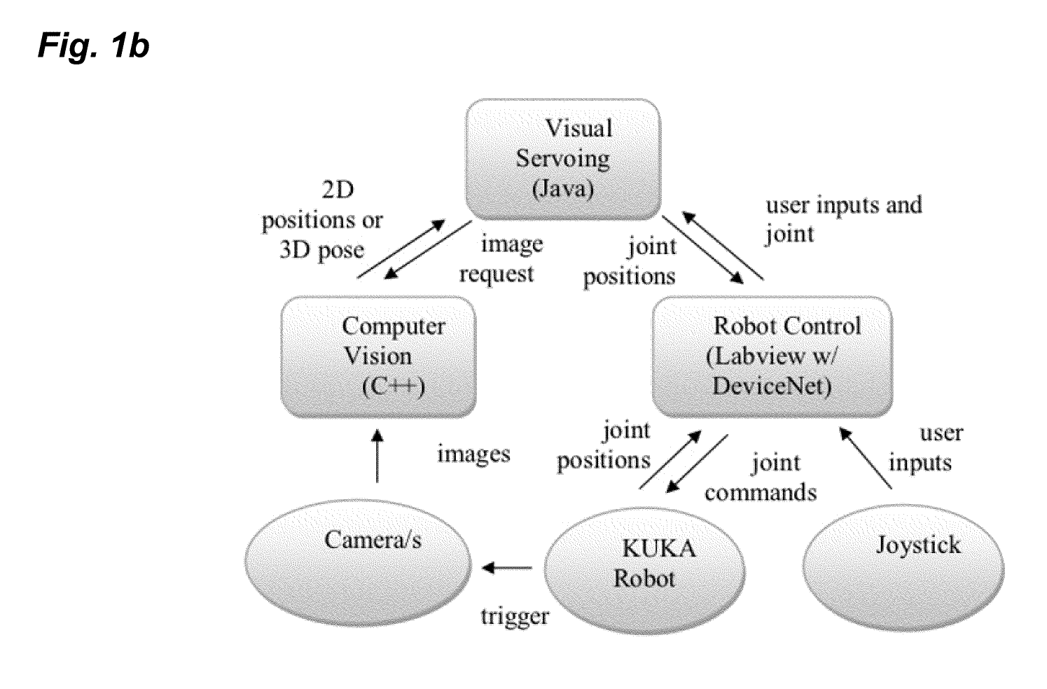

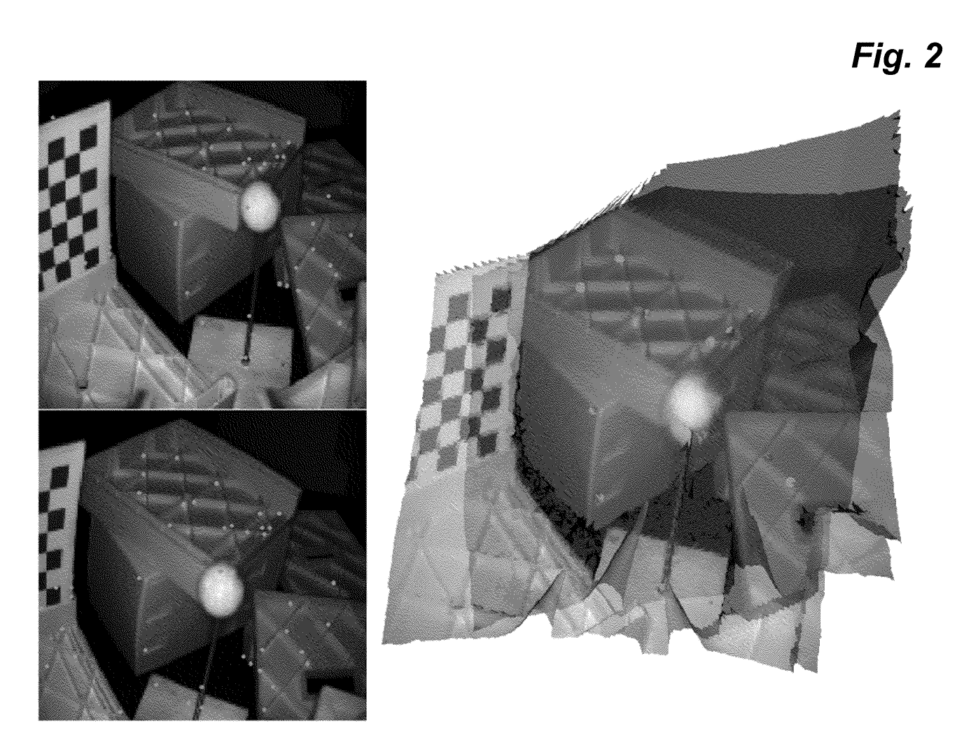

An exemplary methodology is shown in FIGS. 2 and 3, wherein the TOF camera can yield intensity, 3-D, and confidence images. The intensity image is similar to a standard grayscale image and is based purely on the light intensity returned to the camera from an object. The 3-D image returns the 3-D position of each pixel in the frame. Finally, the confidence image is a grayscale image that indicates the estimated amount of error in the 3-D solution for each pixel. The confidence image plays an important role in accurate data analysis. Distinct feature points, or key points, can be found in the images, which can then be matched from one image to the next for comparison. The 3-D data at each point can then be used to compute a transformation solution.

In some embodiments, after the images are obtained, the confidence image can be thresholded (i.e., marked as object pixels if they are above or below some threshold value). In some embodiments, the confidence image can then be eroded (i.e., the value of the output pixel is the minimum value of all the pixels in the input pixel's neighborhood). In this configuration, the image can then be used as a mask for detecting feature points with reliable 3D data. In some embodiments, feature points can be detected in the resulting 2-D grayscale image using a computer vision feature detector such as, for example and not limitation, the FAST feature detector.1 The descriptions of these keypoints can then be found with an appropriate keypoint detector such as, for example and not limitation, the SURF descriptor.2 ¹ E. Rosten and T. Drummond, “Machine learning for high-speed corner detection,” European Conference on ComputerVision, May 2006 (incorporated herein by reference).² H. Bay, T. Tuytelaars, and L. V. Gool, “Surf: Speeded up robust features-demonstration,” Computer Vision ECCV, 2006 (incorporated herein by reference).

In some embodiments, the 2-D keypoints can then be matched with keypoints found in the previous image using, for example and not limitation, a K-Nearest-Neighbors algorithm on the high dimensional space of the descriptors. For each current keypoint, therefore, the nearest k previous keypoints can be located and can all become initial matches. These initial matches can then be filtered to the single best cross correlated matches and to those satisfying the epipolar constraint, e.g., a fundamental matrix solution with random sample consensus (“RANSAC”). Finally, in some embodiments, using the 3D coordinates of the current keypoint matches, the 3-D transformation solution can be computed using a 3D-3D transformation solver. In some embodiments, RANSAC can be used again for further filtering.

As discussed above, distinct feature points (e.g., corners) can be located in the images and then matched from one image to the next. The 3D data at each point can then be used to compute a transformation solution. Feature points are detected and labeled using the FAST Feature Detector and SURF Descriptor. Matches between two images can be found using a K-Nearest-Neighbors (KNN) lookup. In some embodiments, to simplify downstream filtering, only the single best cross correlated matches can be kept. In addition, these can be further filtered by keeping only matches that satisfy the epipolar constraint via the fundamental matrix. Finally, the 3D transformation solution, also a final match filter, can be computed using a RANSAC implementation of a 3D-3D transformation solver. In some embodiments, OpenCV implementations of the detection, descriptor, KNN matching, and fundamental matrix solutions can be used.

B. Assigned Manipulation Task

To demonstrate the effectiveness of using visual servoing, trials were performed with human operation of the robot performing an object manipulation task with eleven different operators. The visual servoing method was then compared to traditional joint-based guidance for two different scenarios: 1) the target object in line of sight and 2) the target object visible only in camera view. Thus each volunteer performs four tests. In other words the four cases are:
Line of sight, joint mode: The operator only has line of sight to the robot. The buttons on the gamepad are mapped to individual robot joints
Line of sight, VS mode: The operator only has line of sight to the robot. The buttons on the gamepad are mapped to the Cartesian frame of the camera
Camera view, joint mode: The operator sees only the monitor displaying the intensity image from the eye-in-hand camera. The buttons on the gamepad are mapped to individual robot joints
Camera view, VS mode: The operator sees only the monitor displaying the intensity image from the eye-in-hand camera. The buttons on the gamepad are mapped to the Cartesian frame of the camera

In each case the operator is required to move to, and grasp (using a custom end-of-arm gripper, see FIG. 1a) a two-inch diameter ball. In this case, the gripper is able to open to a width of two-and-a half inches, providing a one-half inch clearance. The robot and the ball start in the same positions for each operator. These positions are such that the ball is in the camera's field of view at the start of the task and is approximately one meter from the camera. Each trial was deemed complete when the user had closed the gripper on the ball.

C. Results of Human Trials

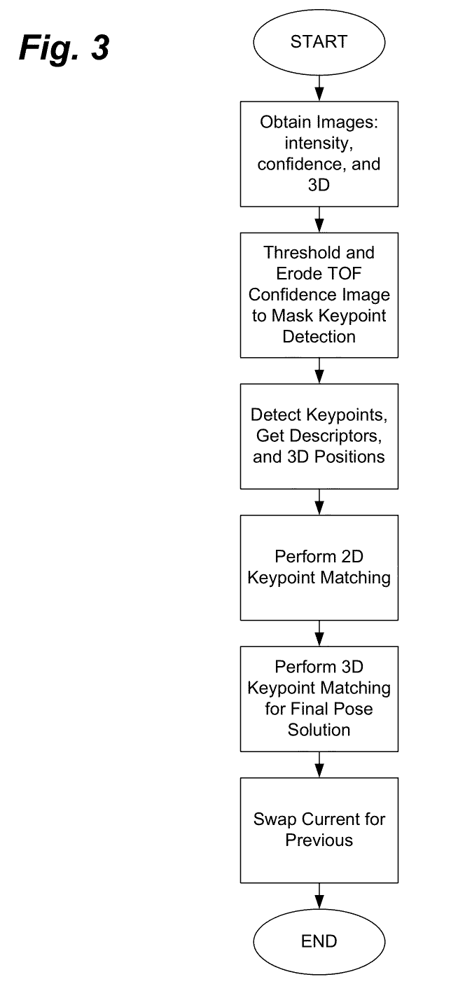

All participants completed the task with both control modes in both scenarios. Analysis of the time required to complete the task in the four different situations shows that when using VS mode in the line-of-sight scenario, however, operator speed increased by an average of 15% compared to using joint mode. When using VS mode in the camera-view only situation, on the other hand, the operator completed the task an average of 227% faster in VS mode than in joint mode. The data regarding time to complete the task is summarized in FIG. 4. In FIG. 4, box plots depict the smallest observation, lower quartile, median, upper quartile, and the largest observation.

In addition to time-to-complete, another metric regarding ease of use for the operator is a count of the number of times the user input (gamepad position) changes direction during the task. In other words, an instance when the operator moved from pressing one button, or joystick direction, to another. This is some indication of the fluidity and efficiency with which the operator was able to achieve the task. As shown in FIG. 5, in VS mode, there is an average two-fold decrease in the number of direction changes for the line-of-sight scenario and a four-fold decrease for the camera-view scenario.

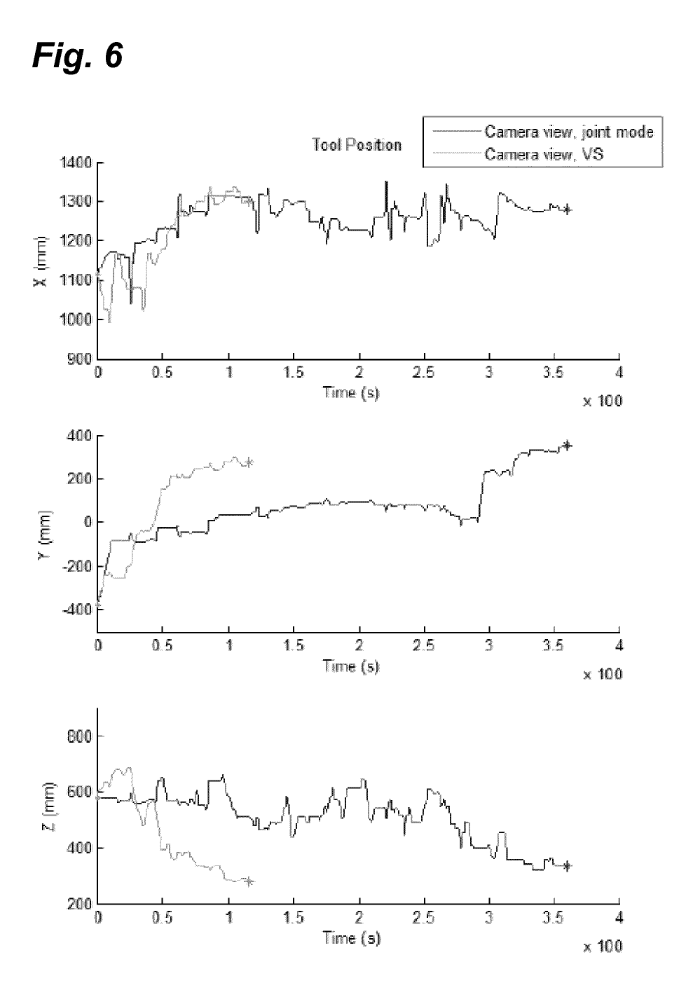

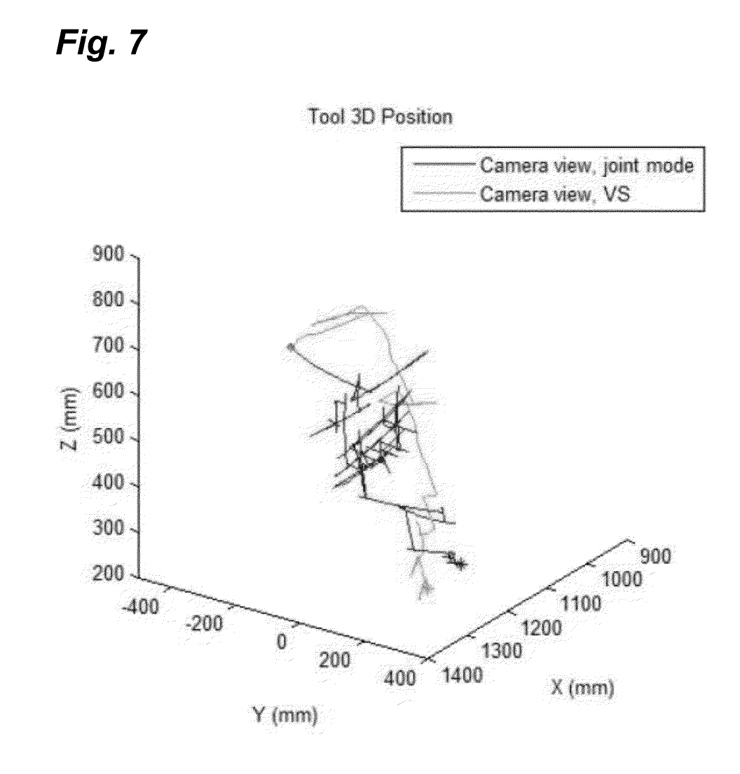

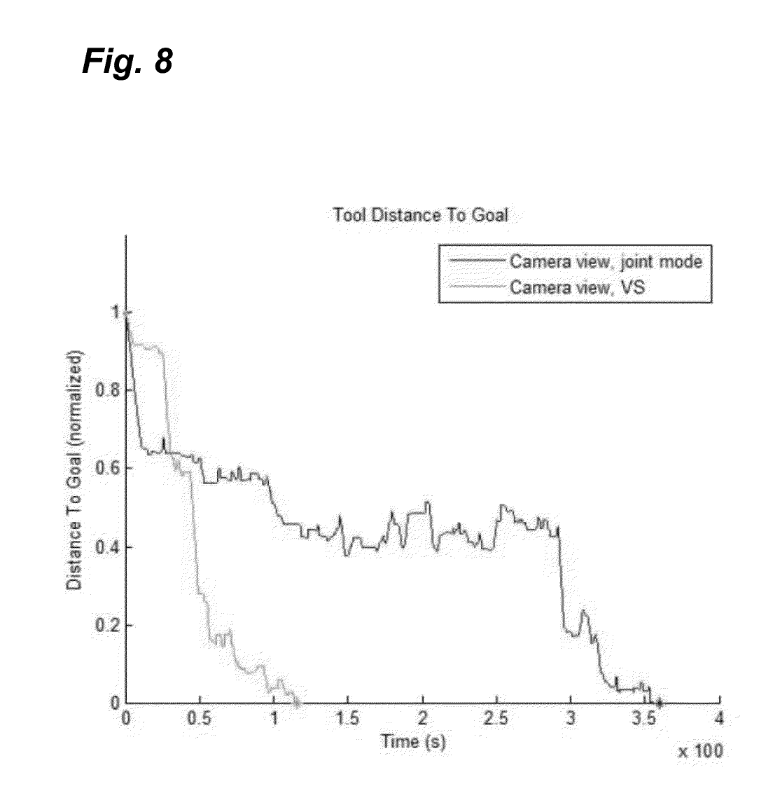

For both modes of operation (i.e., joint and VS) in the camera-view only scenario, information regarding the 3-D path taken by the robot gripper for a representative operator is shown in FIGS. 6, 7, and 8. In FIG. 6 the X, Y, and Z coordinates of the gripper in the world Cartesian system are plotted vs. time. FIG. 7 traces this path in a 3-D plot. The distance between the gripper and the ball (the target), normalized with respect to its starting value, is plotted versus time in FIG. 8. As shown in the figures, the operator is able to guide the robot to the goal more efficiently and directly when using VS than when using joint mode.

### CONCLUSION

Embodiments of the present invention relate to a control method based on uncalibrated visual servoing for the remote and/or teleoperation of a robot. Embodiments of the present invention can comprise a method using commands issued by the operator via a controller (e.g., buttons and/or joysticks on a hand-held gamepad) and using these inputs to drive a robot joint in the desired direction or to a desired position.

Human trials in operating a six degree-of-freedom articulated arm robot performing a simple manipulation task demonstrate the effectiveness of the system and method. Significant improvements were observed for the visual servoing mode of operation. Operators were consistently able to complete a manipulation task faster and with fewer commands with a more direct path.

This 6-DOF Cartesian control can be implemented with a stereo camera, a 3-D camera, or a 2-D camera with a 3-D pose solution (e.g., using structure from motion techniques). In addition, the work presented here need not be limited to Cartesian control with a 3-D sensor, but rather can enable a user to guide a robot regardless of the frame of the measurements. Embodiments of the present invention can also be used, for example and not limitation, in conjunction with a 3-DOF control and a standard 2-D eye-in-hand camera. Indeed, the system and method need not be limited to eye-in-hand camera scenarios, but can be used anytime the user interface and vision system are capable of control and feedback of the desired coordinates.

While several possible embodiments are disclosed above, embodiments of the present invention are not so limited. For instance, while several possible applications have been discussed, other suitable applications could be selected without departing from the spirit of embodiments of the invention. Embodiments of the present invention are described for use with an EOD robot. One skilled on the art will recognize, however, that the intuitive visual control could be used for a variety of applications including, but not limited to, drone aircraft, remote control vehicles, and industrial robots. The system could be used, for example, to drive, and provide targeting for, remote control tanks. In addition, the software, hardware, and configuration used for various features of embodiments of the present invention can be varied according to a particular task or environment that requires a slight variation due to, for example, cost, space, or power constraints. Such changes are intended to be embraced within the scope of the invention.

The specific configurations, choice of materials, and the size and shape of various elements can be varied according to particular design specifications or constraints requiring a device, system, or method constructed according to the principles of the invention. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A method for providing visual based, intuitive control comprising:
moving one or more elements on a device;
measuring the movement of the one or more elements physically with one or more movement sensors mounted on the one or more elements;
measuring the movement of the one or more elements visually with one or more visual based sensors;
comparing the measurement from the one or more movement sensors to the measurement from the one or more visual based sensors to create a control map; and
inverting the control map to provide visual based control of the device.

2. The method of claim 1, further comprising:
receiving a control input from a controller to move the device in a first direction with respect to the visual based sensor; and
transforming the control input to move the one or more elements of the device to move the device in the first direction.

3. The method of claim 2, wherein the controller comprises one or more joysticks.

4. The method of claim 1, wherein the one or more visual based sensors comprise a 2-D video camera.

5. The method of claim 1, wherein the one or more visual based sensors comprise stereoscopic 2-D video cameras.

6. The method of claim 1, wherein the device is a robotic arm;
wherein the one or more elements comprise one or more joints; and
wherein each of the one or more joints rotates, translates, or both.

7. The method of claim 1, wherein visually measuring the movement of the one or more elements comprises:
identifying one or more key objects in a first image captured by the visual based sensor;
moving one or more of the elements of the device;
reidentifying the one or more key objects in a second image captured by the visual based sensor; and
comparing the relative location of the one or more key objects in the first image and the second image.

8. A system for providing visual based, intuitive control comprising:
a device comprising one or more moveable elements each element capable of translation, rotation, or both, and each element comprising one or more movement sensors for physically measuring the movement of the element;
one or more image sensors for visually measuring the movement of the one or more elements; and
a computer processor for:
receiving physical movement data from the one or more movement sensors;
receiving visual movement data from the one or more image sensors;
comparing the physical movement data to the visual movement data to create a control map; and
inverting the control map to provide visual based control of the device.

9. The system of claim 8, the computer processor further:
receiving a control input from a controller to move the device in a first direction with respect to the visual based sensor; and
transforming the control input to move the one or more elements of the device to move the device in the first direction.

10. The system of claim 9, wherein the device comprises a robotic arm with one or more joints.

11. The system of claim 10, the robotic arm further comprising an end-effector.

12. The system of claim 8, wherein the one or more image sensors comprise one or more 3-D time-of-flight cameras.

13. The system of claim 8, wherein the one or more image sensors comprise one or more infrared cameras.
